(19) United States
(12) Patent Application Publication
(10) Pub. No.: US 2008/0108010 A1
(43) Pub. Date: May 8, 2008

(54) Illuminator for a dental drill

(76) Inventor: Wen-Hao Wang, Taipei City (TW)

Correspondence Address: BIRCH STEWART KOLASCH & BIRCH, PO BOX 747, FALLS CHURCH, VA, 22040-0747, US

(21) Appl. No.: 11/593,555

(22) Filed: Nov. 7, 2006

(51) Int. Cl. A61C 1/00

(52) U.S. Cl. 433/29

(57) ABSTRACT

The present invention discloses an illuminator for a dental drill, which comprises a body having a front end and a rear end and having an accommodation room thereinside, a drill installed at the front end of the body, and an illuminator having a light-emitting diode (LED). The body further has an opening-located portion, and the opening-located portion has a through-hole. The LED is installed in the through-hole and has a light-emitting portion facing outward from the through-hole. The present invention adopts a LED as the light source and is simpler and cheaper than the conventional illuminator using an electric bulb or optical fibers.

### FIELD OF THE INVENTION

The present invention relates to an illuminator, particularly to an illuminator for a dental drill.

### BACKGROUND OF THE INVENTION

In addition to high precision and sophisticated skill, a dentist also needs appropriate illumination for the oral cavity in a dental therapeutic process, especially in a dental-polishing or dental-drilling process. Traditionally, the illumination is implemented with an external light source. As the dentist usually has to hold a dental mirror with one hand and take a dental drill with the other hand, the external light source is placed inside the oral cavity of the patient with a frame. However, such an illumination method inconveniences the dentist because light is apt to be blocked. Therefore, a U.S. Pat. No. 5,049,070 disclosed a dental drill, wherein a bundle of optical fibers 2 is used to guide light to the front end of the drill 1 to compensate the external light source and directly illuminate the oral cavity of the patient, and the oral cavity may thus has more abundant light, as shown in FIG. 2. The abovementioned scheme can solve the illumination problem of a dental drill, but the optical fiber is pretty expensive. Further, the dental drill needs to have an extra sleeve to accommodate the optical fibers 2 and lead the optical fibers 2 to the front end of the drill 1; thus, the structure thereof becomes more complicated, and the fabrication cost thereof increases. An electric bulb 3 is used as the light source in the scheme, but the service life of the electric bulb 3 is limited. Furthermore, as the electric bulb 3 is installed inside the body of the dental drill and at the terminal of the optical fibers 2, the replacement of the electric bulb 3 is not so easy.

### SUMMARY OF THE INVENTION

The primary objective of the present invention is to provide an illuminator for a dental drill, wherein the light-emitting diode (LED) replaces the traditional electric bulb as the light source to overcome the short service life of the electric bulb and achieve power efficiency and stable brightness.

Another objective of the present invention is to provide an illuminator for a dental drill, wherein LED is used as the light source, and the fabrication cost of the illuminator of the present invention is thus lower than that of the traditional illuminator using optical fibers.

According to a preferred embodiment, the illuminator for a dental drill of the present invention comprises a body, a drill and an illuminator The body has a front end, and the interior of the body is an accommodation room. The drill is installed at the front end of the body. The body also has an opening-located portion, and the opening-located portion has a through-hole. The illuminator further comprises a LED and a cable. The LED is installed in the through-hole and has a light-emitting portion facing outward from the through-hole. One end of the cable is connected to the LED, and the other end extends through the accommodation room and toward the rear end of the body. The illuminator of a dental drill of the present invention can cost-efficiently take the place of the conventional illuminator that uses expensive optical fibers to conduct light. Further, the LED used by the present invention has a service life much longer that that of the conventional electric bulb.

### BRIEF DESCRIPTION OF THE DRAWINGS

FIG. 1 is a perspective view of a preferred embodiment of the present invention.

FIG. 2 is a sectional view of a dental drill with a conventional illuminator using optical fibers to conduct light.

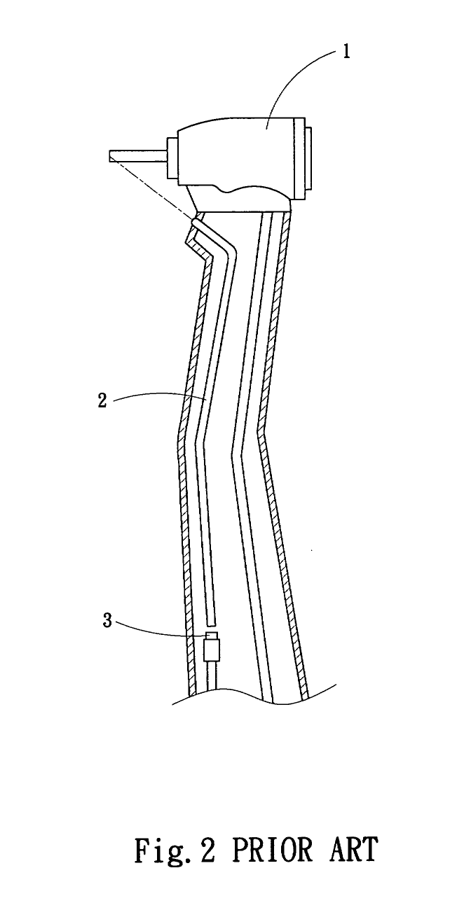

FIG. 3 is a sectional view of a preferred embodiment of the present invention.

FIG. 4 is a sectional view of another preferred embodiment of the present invention.

### DETAILED DESCRIPTION OF THE PREFERRED EMBODIMENTS

The technical contents of the present invention are to be described in detail in cooperation with the drawings below.

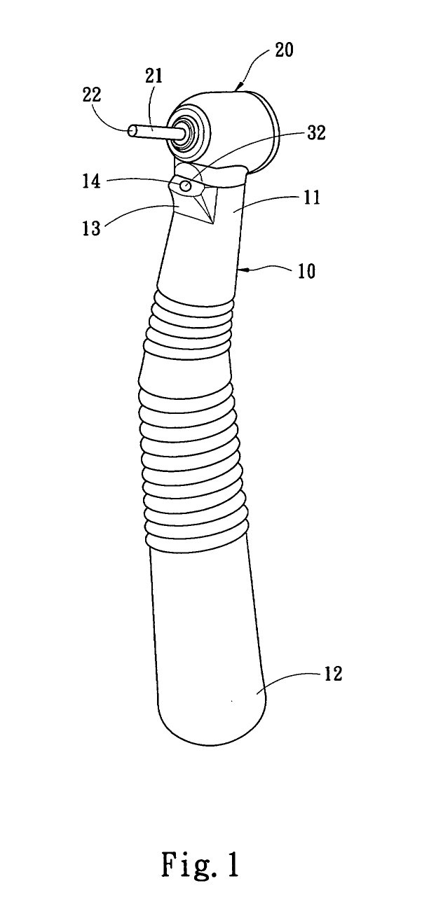

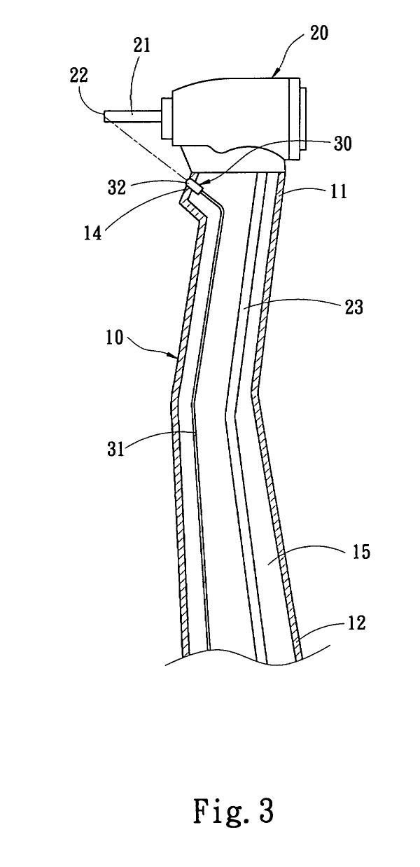

Refer to FIG. 1 and FIG. 3 respectively a perspective view and a sectional view of a preferred embodiment of the present invention. In this preferred embodiment, the illuminator for a dental drill of the present invention comprises a body 10 having a front end 11 and a rear end 12 and having an accommodation room 15 thereinside, a drill 20 installed at the front end 11 of the body 10, and an illuminator having a light-emitting diode (LED) 30 and a cable 31. The body 10 further has an opening-located portion 13, and the opening-located portion 13 has a through-hole 14. The LED 30 is installed in the through-hole 14 and has a light-emitting portion 32 facing outward from the through-hole 14. One end of the cable 31 is connected to the LED 30, and the other end extends through the accommodation room 15 and toward the rear end 12 of the body 10. The drill 20 has an air hose 23, which transports the compressed air supplied from the exterior (not shown in the drawings) and provides pneumatic driving force for the drill 20. The drill 20 has a replaceable drill bit 21, and the tip of the drill bit 21 is defined to be a working region 22. In implementing the present invention, the through-hole 14 of the opening-located portion 13 may be faced toward the working region 22, and the light-emitting portion 32 of the LED 30, which is installed in the through-hole 14, may be pointed toward the working region 22. The rear end 12 of the body 10 may be coupled to a conventional conduit (not shown in the drawings) to obtain the required electric power and compressed air.

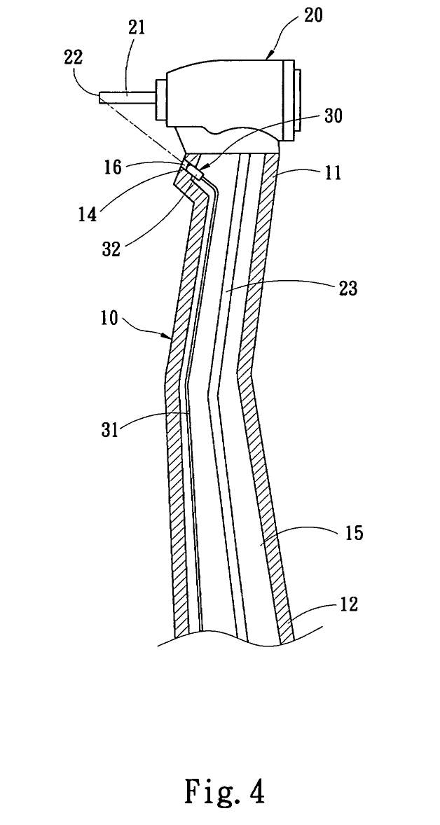

Refer to FIG. 4 a sectional view of another preferred embodiment of the present invention. In this preferred embodiment, the body 10 has a lens 16 installed in the through-hole 14 of the opening-located portion 13 and used to block external humidity and protect the parts of the drill 20.

In this preferred embodiment, the LED 30 having a smaller size and a longer service life is installed in the through-hole 14 of the opening-located portion 13 to replace the conventional illuminator that uses optical fibers to conduct light. The rear end 12 of the body 10 may be coupled to a conventional conduit (not shown in the drawings) to obtain the required electric power and compressed air. Those described above are the preferred embodiments to exemplify the present invention. However, it is not intended to limit the scope of the present invention. Any equivalent modification and variation according to the spirit of the present invention is to be also included within the scope of the present invention.

What is claimed is:

1. An illuminator for a dental drill, comprising:
a body, having a front end and having an accommodation room thereinside;
a drill, installed at said front end of said body; and
an illuminator, having a light-emitting diode (LED), wherein said body further has an opening-located portion, and said opening-located portion has a through-hole; said LED is installed in said through-hole and further has a light-emitting portion facing outward from said through-hole.

2. The illuminator for a dental drill according to claim 1, wherein said body has a lens installed in said through-hole of said opening-located portion.

3. The illuminator for a dental drill according to claim 1, wherein said drill has a replaceable drill bit, and the tip of said drill bit is defined to be a working region.

4. The illuminator for a dental drill according to claim 3, wherein said through-hole is faced toward said working region.

5. The illuminator for a dental drill according to claim 3, wherein said light-emitting portion of said LED is pointed toward said working region.

6. The illuminator for a dental drill according to claim 1, wherein said body has a rear end, and said rear end is coupled to a conventional conduit to obtain the required electric power and compressed air.
